(19) United States
(12) Patent Application Publication
(10) Pub. No.: US 2020/0144716 A1
(43) Pub. Date: May 7, 2020

(54) ANTENNA MODULE AND SURROUNDING DETECTION RADAR HAVING THE SAME

(71) Applicant: Industrial Technology Research Institute, Hsin-chu (TW)

(72) Inventor: Guo-Shu HUANG, Hsinchu County (TW)

(21) Appl. No.: 16/218,874

(22) Filed: Dec. 13, 2018

(30) Foreign Application Priority Data
Nov. 5, 2018 (TW) 107139203

(51) Int. Cl. H01Q 3/12; H01Q 21/06; H01Q 1/24

(52) U.S. Cl. CPC H01Q 3/12; H01Q 1/247; H01Q 21/061

(57) ABSTRACT

An antenna module is provided, which includes a first antenna set and a second antenna set. The first antenna set includes a first transmitter end and a first receiver end, and provides a detection range, less than or substantially equal to 180°, in the direction of a first plane. The second antenna set includes a second transmitter end and a second receiver end, and provides a detection range, substantially equal to 180°, in the direction of a second plane. The polarization direction of the first antenna set is perpendicular to the polarization direction of the second antenna set; the first plane, the second plane and the plane where the antenna module is disposed are perpendicular to one another.

### CROSS REFERENCE TO RELATED APPLICATION

All related applications are incorporated by reference. The present application is based on, and claims priority from, Taiwan Application Serial Number 107139203, filed on Nov. 5, 2018, the disclosure of which is hereby incorporated by reference herein in its entirety.

### TECHNICAL FIELD

The technical field relates to an antenna, in particular to an antenna module. The technical field further relates to a surrounding detection radar having the antenna module.

### BACKGROUND

Due to advances of technology, the functions of unmanned aerial vehicles (UAV) keeps being improved. Currently, UAVs have been comprehensively applied to various tasks, such as military, agriculture, disaster rescue, traffic and environmental protection tasks.

Generally speaking, an UAV detects objects via the camera or the lidar installed on the machine body thereof. However, if the visibility of the environment is bad (because of rain, mist, etc.), the camera or lidar cannot effectively detect the objects. Therefore, the UAV is usually provided with a radar to effectively detect the objects.

The currently available radar can detect the positions of the objects, and provide the distance information, angle information and speed information of the objects, so the UAV can effectively detect the objects.

Besides, the currently available radar can be further provided with a rotational structure with motor, which can rotate the radar to increase its detection range and decrease the blind zone in detection.

### SUMMARY

An embodiment of the present disclosure relates to an antenna module, which includes a first antenna set and a second antenna set. The first antenna set includes a first transmitter end and a first receiver end, and provides a detection range, less than or substantially equal to 180°, in the direction of a first plane. The second antenna set includes a second transmitter end and a second receiver end, and provides a detection range, substantially equal to 180°, in the direction of a second plane. The polarization direction of the first antenna set is perpendicular to the polarization direction of the second antenna set; the first plane, the second plane and the plane where the antenna module is disposed are perpendicular to one another.

Another embodiment of the present disclosure relates to a surrounding detection radar, which includes a base having a plurality of installation surfaces, and a plurality of antenna modules disposed on the installation surfaces and distributed along the radial direction of the base; each antenna module includes a first antenna set and a second antenna set. The first antenna set includes a first transmitter end and a first receiver end, and provide a detection range, less than or substantially equal to 180°, in the direction of a first plane. The second antenna set includes a second transmitter end and a second receiver end, and provides a detection range, substantially equal to 180°, in the direction of a second plane. The polarization direction of the first antenna set is perpendicular to the polarization direction of the second antenna set; the first plane, the second plane and the plane where the antenna module is disposed are perpendicular to one another.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a structure diagram of a surrounding detection radar of a first embodiment in accordance with the present disclosure.

FIG. 2 is a schematic view of installing the surrounding detection radar on an UAV of the first embodiment in accordance with the present disclosure.

FIG. 3 is an antenna structure diagram of an antenna module of the surrounding detection radar of the first embodiment in accordance with the present disclosure.

FIG. 4 is a schematic view of the surrounding detection radar of the first embodiment in accordance with the present disclosure.

FIG. 5 is a curve chart of phase difference and incident angle of the surrounding detection radar of the first embodiment in accordance with the present disclosure.

FIG. 6 is a circuit diagram of the antenna module of the surrounding detection radar of the first embodiment in accordance with the present disclosure.

FIG. 7 is a structure diagram of a surrounding detection radar of a second embodiment in accordance with the present disclosure.

FIG. 8 is an antenna structure diagram of an antenna module of the surrounding detection radar of the second embodiment in accordance with the present disclosure.

FIG. 9 is a structure diagram of a surrounding detection radar of a third embodiment in accordance with the present disclosure.

FIG. 10 is a structure diagram of a surrounding detection radar of a fourth embodiment in accordance with the present disclosure.

FIG. 11 is an antenna structure diagram of an antenna module of the surrounding detection radar of the fourth embodiment in accordance with the present disclosure.

FIG. 12A and FIG. 12B are radiation pattern diagrams of the surrounding detection radar of the fourth embodiment in accordance with the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

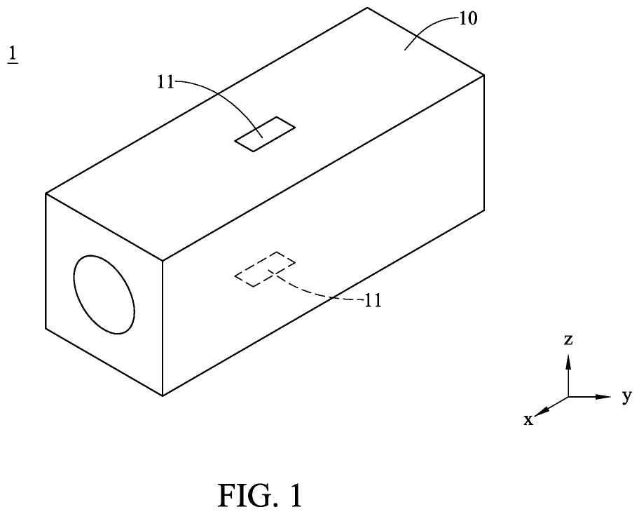

FIG. 1 is a structure diagram of a surrounding detection radar of a first embodiment in accordance with the present disclosure. As shown in FIG. 1, the surrounding detection radar 1 includes a base 10 and 2 antenna modules 11. In the embodiment, the base 10 is a rectangular prism and includes 2 installation surfaces. The antenna modules 11 are disposed on the installation surfaces respectively and distributed along the radial direction of the base 10.

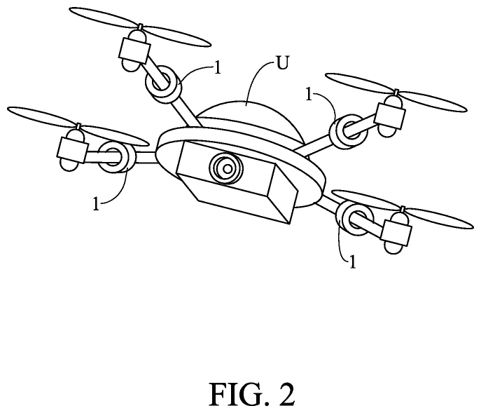

FIG. 2 is a schematic view of installing the surrounding detection radar on an UAV of the first embodiment in accordance with the present disclosure. As shown in FIG. 2, the surrounding detection radar 1 can be installed on the rotor arms of an unmanned aerial vehicle (UAV) and each rotor arm penetrates through the central axis of the base 10. The embodiment is for example instead of limitation; the surrounding detection radar 1 can be also applied to other devices.

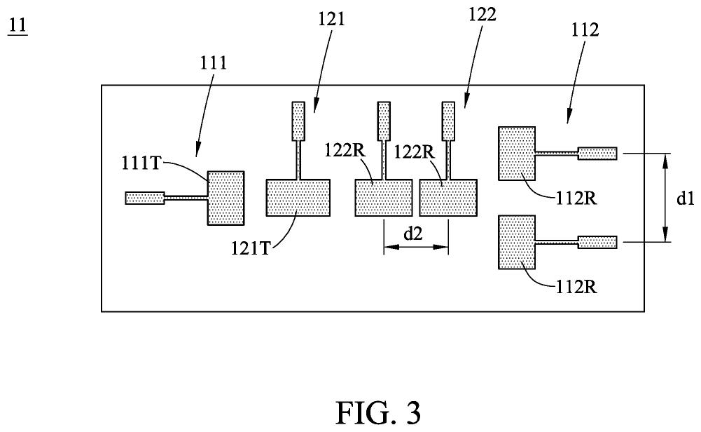

FIG. 3 is an antenna structure diagram of an antenna module of the surrounding detection radar of the first embodiment in accordance with the present disclosure. As shown in FIG. 3, each antenna module 11 includes a first antenna set and a second antenna set.

The first antenna set includes a first transmitter end 111 and a second receiver end 112, and provides the detection range in the direction of a first plane; the detection range in the direction of the first plane is less than or substantially equal to 180°. More specifically, the first plane and the plane where the antenna module 11 is disposed are perpendicular to each other. Take the antenna module 11 disposed at the top of the base 10 of FIG. 1 as an example, the first plane is y-z plane and the plane where the antenna module 11 is disposed is x-y plane.

The first transmitter end 111 includes a first transmitter antenna unit 111T.

The first receiver end 112 includes a first receiver antenna array having 2 first receiver antenna units 112R.

The second antenna set includes a second transmitter end 121 and a second receiver end 122, and provides the detection range in the direction of a second plane; the detection range in the direction of the second plane is substantially equal to 180°. More specifically, the second plane, the first plane and the plane where the antenna module 11 is disposed are perpendicular to one another. Take the antenna module 11 disposed at the top of the base 10 of FIG. 1 as an example, the second plane is x-z plane.

The second transmitter 121 includes a second transmitter antenna unit 121T.

The second receiver end 122 includes a second receiver antenna array having 2 second receiver antenna units 122R.

The polarization direction of the first antenna set is perpendicular to the polarization direction of the second antenna set.

Via the above design, the antenna module 11 can achieve the detection range of 180° in the first plane (y-z plane) and achieve the detection range of 180° in the second plane (x-z plane). As shown in FIG. 1, the antenna modules 11 are disposed on the 2 installation surfaces of the base 10 of the surrounding detection radar 1 and distributed along the radial direction of the base 10, such that the coverage of the antenna modules 11 includes all of the radial and axial directions of the base 10. Accordingly, the surrounding detection radar 1 can achieve the ability of 3D surrounding scanning.

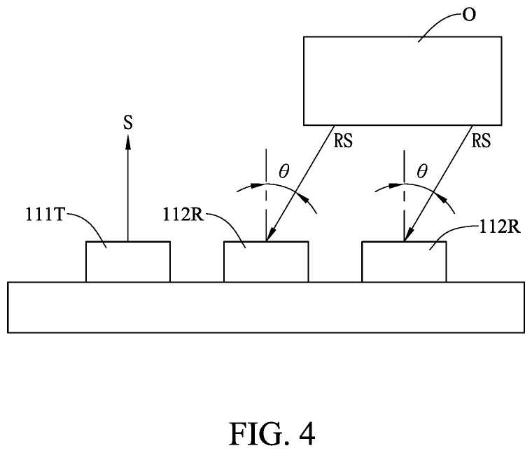

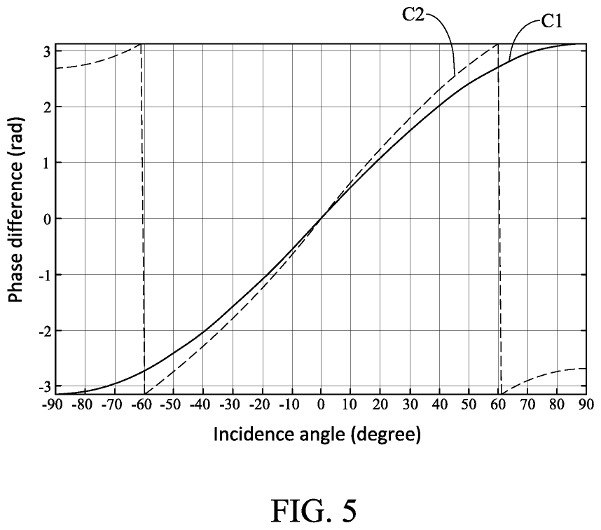

FIG. 4 and FIG. 5 are a schematic view and a curve chart of phase difference and incident angle of the surrounding detection radar of the first embodiment in accordance with the present disclosure respectively. As shown in FIG. 4, the first transmitter antenna unit 111T transmits a signal S to an object O, and the first receiver antenna units 112R receives signals RS reflected from the object O. Then, the angle information, in the first plane, of the object O can be obtained according to the phase difference between the signals RS received by the first receiver antenna units 112R, as shown in Equation (1):

$$θ = {sin}^{- 1} \frac{λΔ φ}{2 π d} \qquad ( 1 )$$

In Equation (1), θ stands for the incident angle; d1 stands for the distance between the center of the first receiver antenna unit 112R to the center of the other first receiver antenna unit 112R; λ stands for the wavelength; φ stands for the phase difference.

As shown in FIG. 5, the incident angles corresponding to the phase differences can be obtained by referring to a look-up table. Thus, the angle, in the direction of the first plane, of the object O can be obtained according to the phase difference between the first receiver antenna units 112R, as shown by the curve C1. Similarly, the angle, in the direction of the second plane, of the object O can be obtained according to the phase difference between the second receiver antenna units 122R, as shown by the curve C2 (d2 stands for the distance between the center of the second receiver antenna unit 122R to the center of the other second receiver antenna unit 122R). In the embodiment, when the quantity of the installation surfaces of the base 10 is 2, the quantity of the first transmitter antenna units 111T of the first transmitter end 111 is greater than or equal to 1, and d1 and d2 are slightly less than or substantially equal to ½ wavelength (about 0.4-0.5 wavelength) of the operating frequency of the antenna module 11.

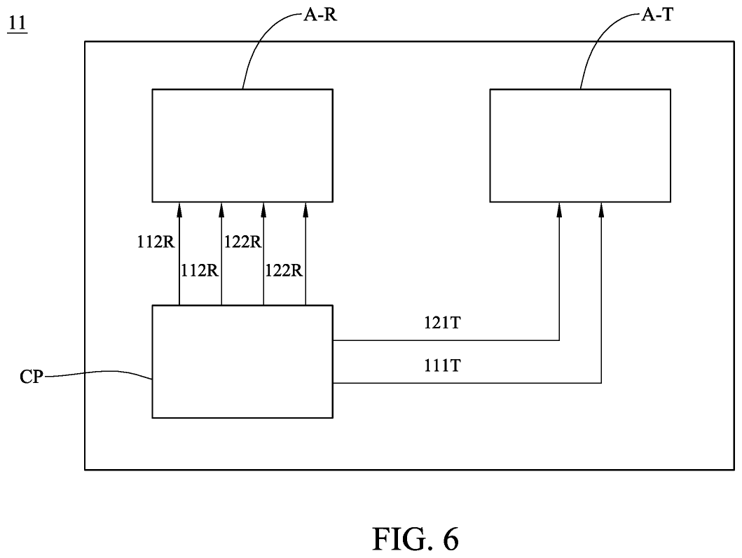

FIG. 6 is a circuit diagram of the antenna module of the surrounding detection radar of the first embodiment in accordance with the present disclosure. The embodiment illustrates the circuit structure of the antenna module 11. As shown in FIG. 6, the antenna module 11 further includes a control chip CP, and the first transmitter end 111 and the second transmitter end 121 are integrated into the transmitter circuit A_T and the receiver circuit A_R respectively, and connected to the control chip CP.

The transmitter circuit A_T includes a first transmitter end 111 and a second transmitter end 121.

The receiver circuit A_R includes a first receiver end 112 and a second receiver end 122.

The control chip CP is connected to the transmitter circuit A_T and the receiver circuit A_R to drive the first transmitter antenna unit 111T, the second transmitter antenna unit 121T, the first receiver antenna units 112R and the second receiver antenna units 122R.

The embodiment just exemplifies the present disclosure and is not intended to limit the scope of the present disclosure. Any equivalent modification and variation according to the spirit of the present disclosure is to be also included within the scope of the following claims and their equivalents.

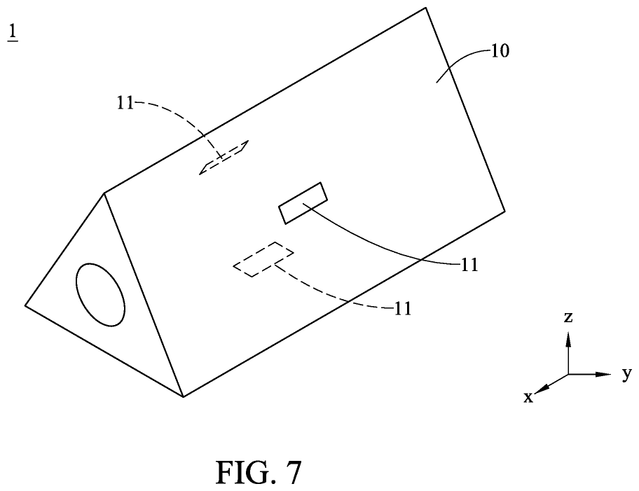

FIG. 7 is a structure diagram of a surrounding detection radar of a second embodiment in accordance with the present disclosure. As shown in FIG. 7, the surrounding detection radar 1 includes a base 10 and 3 antenna modules 11. In the embodiment, the base 10 is a triangular prism and includes 3 installation surfaces. The antenna modules 11 are disposed on the installation surfaces respectively and distributed along the radial direction of the base 10.

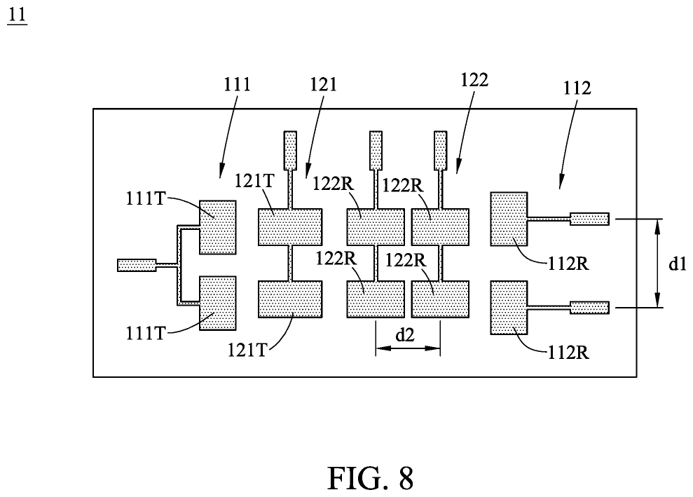

FIG. 8 is an antenna structure diagram of an antenna module of the surrounding detection radar of the second embodiment in accordance with the present disclosure. As shown in FIG. 8, each antenna module 11 includes a first antenna set and a second antenna set.

The first antenna set includes a first transmitter end 111 and a second receiver end 112. The base 10 in the embodiment includes 3 installation surfaces, and the antenna modules 11 are disposed on the installation surfaces respectively and distributed along the radial direction of the base 10. Therefore, the detection range, in the direction of a first plane, of each antenna module 11 is substantially equal to 120°. In this way, the detection range, in the direction of the first plane, of all antenna modules 11 can achieve 360°. Similarly, the first plane and the plane where each antenna module 11 is disposed are perpendicular to each other.

The first transmitter end 111 includes a first transmitter antenna array having 2 first transmitter antenna units 111T connected in parallel.

The first receiver end 112 includes a first receiver antenna array having 2 first receiver antenna units 112R, where d1 stands for the distance between the center of the first receiver antenna unit 112R to the center of the other first receiver antenna unit 112R. In the embodiment, d1 is substantially equal to ½ wavelength of the operating frequency of the antenna module 11.

The second antenna set includes a second transmitter end 121 and a second receiver end 122, and provides the detection range in the direction of a second plane; the detection range in the direction of the second plane is substantially equal to 180°. Similarly, the second plane, the first plane and the plane where the antenna module 11 is disposed are perpendicular to one another.

The second transmitter 121 includes a second transmitter antenna array having 2 second transmitter antenna units 121T connected in series.

The second receiver end 122 includes 2 second receiver antenna arrays and each has 2 second receiver antenna units 122R. More specifically, d2 stands for the distance between the center of the second receiver antenna array to the center of the other second receiver antenna array. In the embodiment, d2 is substantially equal to ½ wavelength of the operating frequency of the antenna module 11.

Similarly, the polarization direction of the first antenna set is perpendicular to the polarization direction of the second antenna set.

As described above, the first transmitter end 111 includes an antenna array having 2 antenna units connected in parallel; the second transmitter end 121 and the second receiver end 122 also include an antenna array respectively and each antenna array includes 2 antenna units connected in series. In other words, the quantity of the antenna units connected in parallel of the first transmitter end 111 is proportional to the quantity of the installation surfaces. The quantity of the antenna units connected in series of the second transmitter end 121 is proportional to the quantity of the installation surfaces. Similarly, the quantity of the antenna units connected in series of the second receiver end 122 is proportional to the quantity of the installation surfaces. The above arrangement can narrow the beam width of the antenna module 11 in the direction of the first plane in order to achieve the detection range of 360°/N; N stands for the quantity of the installation surfaces.

Via the above antenna structure, the beam width, in the direction of the first plane, of the antenna module 11 can be narrowed to achieve the detection range of 120° in order to enhance the gain, in the direction of the first plane, of the antenna module 11. Besides, the above antenna structure can also enhance the gain, in the direction of the second plane, of the antenna module 11, but the detection range, in the direction of the second plane, of the antenna module 11 is still 180°. Thus, compared with the first embodiment, the antenna module 11 of the embodiment can achieve higher gain.

When the quantity of the installation surfaces of the base 10 is 3, the quantity of the first transmitter antenna units 111T connected in parallel of the first transmitter end 111 is greater than or equal to 2; besides, d1 and d2 are substantially equal to ½ wavelength of the operating frequency of the antenna module 11. Via the above antenna design, the antenna module 11 can achieve the detection range of 120° in the first plane and achieve the detection range of 180° in the second plane. As shown in FIG. 7, the antenna modules 11 are disposed on the 3 installation surfaces of the base 10 of the surrounding detection radar 1 respectively and distributed along the radial direction of the base 10, such that the coverage of the antenna modules 11 includes all of the radial and axial directions of the base 10. Accordingly, the surrounding detection radar 1 can achieve the ability of 3D surrounding scanning

The embodiment just exemplifies the present disclosure and is not intended to limit the scope of the present disclosure. Any equivalent modification and variation according to the spirit of the present disclosure is to be also included within the scope of the following claims and their equivalents.

It is worthy to point out that the currently available radars can implement detection in only one direction because of the limits due to the structure design, which limits the detection range of the radars; thus, the currently available radars tend to have larger blind zone in detection. On the contrary, according to one embodiment of the present disclosure, the surrounding detection radar includes a plurality of antenna modules distributed along the radial direction of the base and the antenna modules have special design, such that the surrounding detection radar can achieve large detection range and the ability of 3D surrounding scanning

Moreover, the currently available radars should be further provided with the rotational structures with motor, which can rotate the radars to increase the detection range and decrease the blind zone in detection; however, the rotational structure significantly increases the weight and the volume of the radars, which limits the applications of the radars. On the contrary, according to one embodiment of the present disclosure, the surrounding detection radar can realize the ability of 3D surrounding scanning via electronic mechanism without rotational structure, so the weight and volume of the radar can be reduced; therefore, the surrounding detection radar can be more comprehensively in application.

Furthermore, according to one embodiment of the present disclosure, each of the antenna modules of the surrounding detection radar has antenna arrays with special design, which can enhance the gains of each of the antenna modules in both of the direction of the first plane and the direction of the second plane. Thus, the detection range of the surrounding detection radar can be significantly increased. As described above, the surrounding detection radar according to the embodiments of the present disclosure can definitely provide unpredictable technical effects.

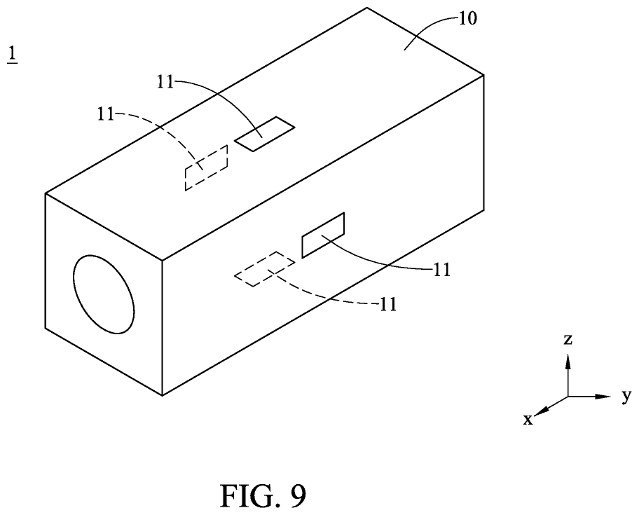

FIG. 9 is a structure diagram of a surrounding detection radar of a third embodiment in accordance with the present disclosure. As shown in FIG. 9, the surrounding detection radar 1 includes a base 10 and 3 antenna modules 11. In the embodiment, the base 10 is a rectangular prism and includes 4 installation surfaces. The antenna modules 11 are disposed on the installation surfaces respectively and distributed along the radial direction of the base 10.

The antenna structure of the antenna module 11 in the embodiment is the same with that of the previous embodiment, so will not be described herein again. The difference between the embodiment and the previous embodiment is that d1 is, in the embodiment, slightly greater than ½ wavelength (about 0.5-0.6 wavelength) of the operating frequency of the antenna module 11; similarly, d2 is, in the embodiment, slightly greater than ½ wavelength (about 0.5-0.6 wavelength) of the operating frequency of the antenna module 11.

The base 10 in the embodiment includes fourth installation surfaces, and the antenna modules 11 are disposed on the installation surfaces respectively and distributed along the radial direction of the base 10. Therefore, the detection range, in the direction of a first plane, of each antenna module 11 is substantially equal to 90°. In this way, the detection range, in the direction of the first plane, of all antenna modules 11 can achieve 360°.

Via the above antenna structure, the beam width, in the direction of the first plane, of the antenna module 11 can be narrowed to achieve the detection range of 90° in order to enhance the gain, in the direction of the first plane, of the antenna module 11. Besides, the above antenna structure can also enhance the gain, in the direction of the second plane, of the antenna module 11, but the detection range, in the direction of the second plane, of the antenna module 11 is still 180°. Thus, compared with the first embodiment, the antenna module 11 of the embodiment can achieve higher gain.

When the quantity of the installation surfaces of the base 10 is 4, the quantity of the first transmitter antenna units 111T connected in parallel of the first transmitter end 111 is greater than or equal to 2; besides, d1 and d2 are slight greater than ½ wavelength of the operating frequency of the antenna module 11. Via the above antenna design, the antenna module 11 can achieve the detection range of 90° in the first plane and achieve the detection range of 180° in the second plane. As shown in FIG. 9, the antenna modules 11 are disposed on the 4 installation surfaces of the base 10 of the surrounding detection radar 1 respectively and distributed along the radial direction of the base 10, such that the coverage of the antenna modules 11 includes all of the radial and axial directions of the base 10. Accordingly, the surrounding detection radar 1 can achieve the ability of 3D surrounding scanning

The embodiment just exemplifies the present disclosure and is not intended to limit the scope of the present disclosure. Any equivalent modification and variation according to the spirit of the present disclosure is to be also included within the scope of the following claims and their equivalents.

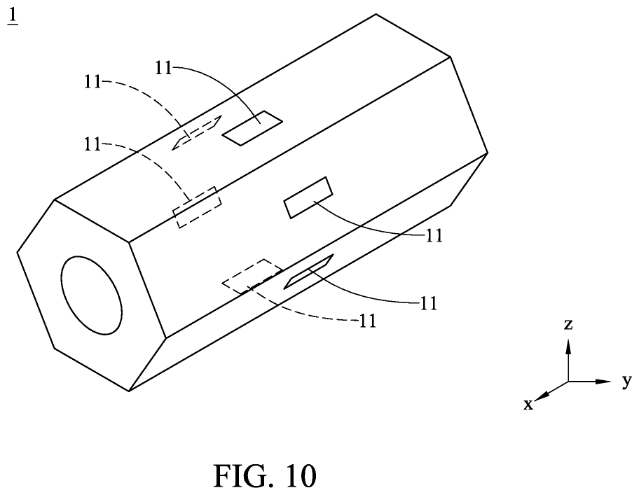

FIG. 10 is a structure diagram of a surrounding detection radar of a fourth embodiment in accordance with the present disclosure. As shown in FIG. 10, the surrounding detection radar 1 includes a base 10 and 6 antenna modules 11. In the embodiment, the base 10 is a hexagonal prism and includes 6 installation surfaces. The antenna modules 11 are disposed on the installation surfaces respectively and distributed along the radial direction of the base 10.

The embodiment just exemplifies the present disclosure and is not intended to limit the scope of the present disclosure. Any equivalent modification and variation according to the spirit of the present disclosure is to be also included within the scope of the following claims and their equivalents.

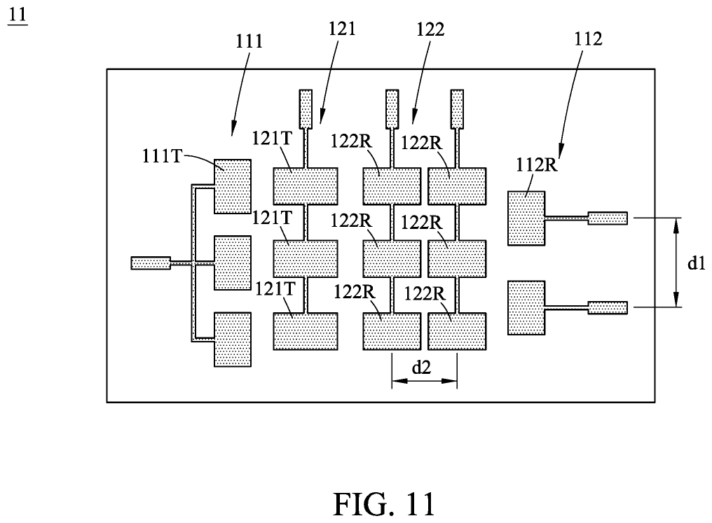

FIG. 11 is an antenna structure diagram of an antenna module of the surrounding detection radar of the fourth embodiment in accordance with the present disclosure. As shown in FIG. 11, each antenna module 11 includes a first antenna set and a second antenna set.

The first antenna set includes a first transmitter end 111 and a second receiver end 112. The base 10 in the embodiment includes 6 installation surfaces, and the antenna modules 11 are disposed on the installation surfaces respectively and distributed along the radial direction of the base 10. Therefore, the detection range, in in the direction of a first plane, of each antenna module 11 is substantially equal to 60°. In this way, the detection range, in the direction of the first plane, of all antenna modules 11 can achieve 360°. Similarly, the first plane and the plane where each antenna module 11 is disposed are perpendicular to each other. Take the antenna module 11 disposed at the top of the base 10 of FIG. 11 as an example, the first plane is y-z plane and the plane where the antenna module 11 is disposed is x-y plane.

The first transmitter end 111 includes a first transmitter antenna array having 3 first transmitter antenna units 111T connected in parallel.

The first receiver end 112 includes a first receiver antenna array having 2 first receiver antenna units 112R, where d1 stands for the distance between the center of the first receiver antenna unit 112R to the center of the other first receiver antenna unit 112R. In the embodiment, d1 is substantially equal to ½ wavelength of the operating frequency of the antenna module 11.

The second antenna set includes a second transmitter end 121 and a second receiver end 122, and provides the detection range in the direction of a second plane; the detection range in the direction of the second plane is substantially equal to 180°. Similarly, the second plane, the first plane and the plane where the antenna module 11 is disposed are perpendicular to one another. Take the antenna module 11 disposed at the top of the base 10 of FIG. 11 as an example, the second plane is x-z plane.

The second transmitter 121 includes a second transmitter antenna array having 3 second transmitter antenna units 121T connected in series.

The second receiver end 122 includes 2 second receiver antenna arrays and each has 3 second receiver antenna units 122R connected in series. More specifically, d2 stands for the distance between the center of the second receiver antenna array to the center of the other second receiver antenna array. In the embodiment, d2 is substantially equal to ½ wavelength of the operating frequency of the antenna module 11.

Similarly, the polarization direction of the first antenna set is perpendicular to the polarization direction of the second antenna set.

As described above, the first transmitter end 111 includes an antenna array having 3 antenna units connected in parallel; the second transmitter end 121 and the second receiver end 122 also include the antenna array respectively and each antenna array includes 3 antenna units connected in series. The above arrangement can further narrow the beam width of the antenna module 11 in the direction of the first plane (i.e. y-z plane) in order to achieve the detection range of 60° so as to further enhance the gain, in the direction of the first plane, of the antenna module 11. Besides, the above antenna structure can also enhance the gain, in the direction of the second plane, of the antenna module 11, but the detection range, in the direction of the second plane, of the antenna module 11 is still 180°. Thus, compared with the previous embodiments, the antenna module 11 of the embodiment can achieve higher gain.

Moreover, the base 10 of the surrounding detection radar 1 may be a triangular prism, a rectangular prism, a pentagonal prism or a hexangular prism, etc. The shape of the base 10 can be changed to increase the quantity of the installation surfaces, which can enhance the gain of the surrounding detection radar 1 in order to satisfy different requirements.

When the quantity of the installation surfaces of the base 10 is 5-6, the quantity of the first transmitter antenna units 111T connected in parallel of the first transmitter end 111 is greater than or equal to 3, and d1 and d2 are substantially equal to ½ wavelength of the operating frequency of the antenna module 11. Via the above antenna design, the antenna module 11 can achieve the detection range of 60° -72° in the first plane and achieve the detection range of 180° in the second plane. As shown in FIG. 10, the antenna modules 11 are disposed on the 6 installation surfaces of the base 10 of the surrounding detection radar 1 respectively and distributed along the radial direction of the base 10, such that the coverage of the antenna modules 11 includes all of the radial and axial directions of the base 10. Accordingly, the surrounding detection radar 1 can achieve the ability of 3D surrounding scanning.

The embodiment just exemplifies the present disclosure and is not intended to limit the scope of the present disclosure. Any equivalent modification and variation according to the spirit of the present disclosure is to be also included within the scope of the following claims and their equivalents.

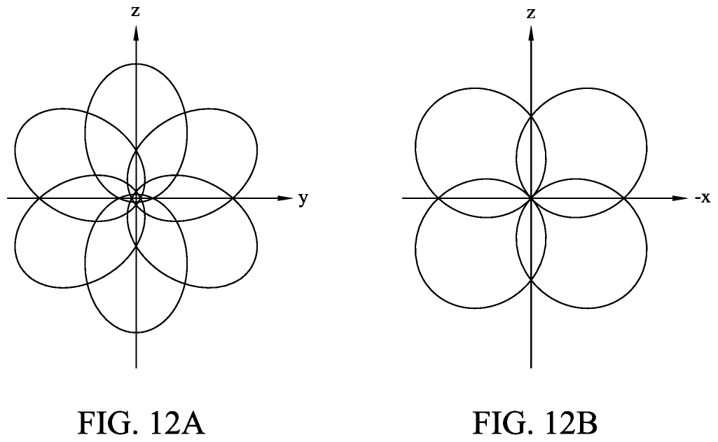

FIG. 12A and FIG. 12B are radiation pattern diagrams of the surrounding detection radar of the fourth embodiment in accordance with the present disclosure. The surrounding detection radar 1 of the embodiment includes 6 antenna modules 11 distributed along the radial direction of the base 10. The direction of the central axis of the base 10 is x axis; FIG. 12A shows the radiation pattern, in y-z plane, of the surrounding detection radar 1 and FIG. 12B shows the radiation pattern, in x-z plane, of the surrounding detection radar 1. According to FIG. 12A and FIG. 12B, the coverage of the surrounding detection radar 1 can include the whole spherical space around the base 10, so can exactly achieve the ability of 3D surrounding scanning

The embodiment just exemplifies the present disclosure and is not intended to limit the scope of the present disclosure. Any equivalent modification and variation according to the spirit of the present disclosure is to be also included within the scope of the following claims and their equivalents.

In summation of the description above, according to one embodiment of the present disclosure, the surrounding detection radar includes a plurality of antenna modules distributed along the radial direction of the base and the antenna modules have special design, such that the surrounding detection radar can achieve large detection range and the ability of 3D surrounding scanning

Besides, according to one embodiment of the present disclosure, the surrounding detection radar can realize the ability of 3D surrounding scanning via electronic mechanism without rotational structure, so the weight and volume of the radar can be reduced; therefore, the surrounding detection radar can be more comprehensively in application.

Moreover, according to one embodiment of the present disclosure, each of the antenna modules of the surrounding detection radar has antenna arrays with special design, which can enhance the gains of each of the antenna modules in both of the direction of the first plane and the direction of the second plane. Thus, the detection range of the surrounding detection radar can be significantly increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An antenna module, comprising:
a first antenna set, comprising a first transmitter end and a first receiver end, and providing a detection range, less than or substantially equal to 180°, in the direction of a first plane; and
a second antenna set, comprising a second transmitter end and a second receiver end, and providing a detection range, substantially equal to 180°, in the direction of a second plane;
wherein a polarization direction of the first antenna set is perpendicular to a polarization direction of the second antenna set; the first plane, the second plane and a plane where the antenna module is disposed are perpendicular to one another.

2. The antenna module of claim 1, wherein the first transmitter end comprises a first transmitter antenna unit, and the first receiver end comprises a first receiver antenna array having 2 first receiver antenna units.

3. The antenna module of claim 2, wherein a distance between the first receiver antenna units is less than or substantially equal to a ½ wavelength of an operating frequency of the antenna module.

4. The antenna module of claim 1, wherein the second transmitter end comprises a second transmitter antenna unit, and the second receiver end comprises a second receiver antenna array having 2 second receiver antenna units.

5. The antenna module of claim 4, wherein a distance between the second receiver antenna units is less than or substantially equal to a ½ wavelength of an operating frequency of the antenna module.

6. The antenna module of claim 1, wherein the first transmitter end comprises a first transmitter antenna array having a plurality of first transmitter antenna units connected in parallel, and the first receiver end comprises a first receiver antenna array having 2 first receiver antenna units.

7. The antenna module of claim 6, wherein a distance between the first receiver antenna units is greater than or substantially equal to a ½ wavelength of an operating frequency of the antenna module.

8. The antenna module of claim 1, wherein the second transmitter end comprises a second transmitter antenna array having a plurality of second transmitter antenna units connected in series, and the second receiver end comprises 2 second receiver antenna arrays having a plurality of second receiver antenna units connected in series.

9. The antenna module of claim 8, wherein a distance between the second receiver antenna arrays is greater than or substantially equal to a ½ wavelength of an operating frequency of the antenna module.

10. A surrounding detection radar, comprising a base having a plurality of installation surfaces, and a plurality of antenna modules disposed on the installation surfaces and distributed along a radial direction of the base, wherein each antenna module comprises:
a first antenna set, comprising a first transmitter end and a first receiver end, and providing a detection range, less than or substantially equal to 180°, in the direction of a first plane; and
a second antenna set, comprising a second transmitter end and a second receiver end, and providing a detection range, substantially equal to 180°, in the direction of a second plane;
wherein a polarization direction of the first antenna set is perpendicular to a polarization direction of the second antenna set; the first plane, the second plane and a plane where the antenna module is disposed are perpendicular to one another.

11. The surrounding detection radar of claim 10, wherein a quantity of the installation surfaces is 2, the detection range of the first antenna set in the first plane is substantially equal to 180° and the detection range of the second antenna set in the second plane is substantially equal to 180°.

12. The surrounding detection radar of claim 11, wherein the first transmitter end comprises a first transmitter antenna unit, and the first receiver end comprises a first receiver antenna array having 2 first receiver antenna units.

13. The surrounding detection radar of claim 12, wherein a distance between the first receiver antenna units is less than or substantially equal to a ½ wavelength of an operating frequency of the antenna module.

14. The surrounding detection radar of claim 11, wherein the second transmitter end comprises a second transmitter antenna unit, and the second receiver end comprises a second receiver antenna array having 2 second receiver antenna units.

15. The surrounding detection radar of claim 14, wherein a distance between the second receiver antenna units is less than or substantially equal to a ½ wavelength of an operating frequency of the antenna module.

16. The surrounding detection radar of claim 10, wherein when a quantity of the installation surfaces is an integer greater than 2, the detection range of the first antenna set in the direction of the first plane is substantially equal to 360° divided by the integer and the detection range of the second antenna set in the second plane is substantially equal to 180°.

17. The surrounding detection radar of claim 16, wherein the first transmitter end comprises a first transmitter antenna array having a plurality of first transmitter antenna units connected in parallel, and the first receiver end comprises a first receiver antenna array having 2 first receiver antenna units.

18. The surrounding detection radar of claim 17, wherein a distance between the first receiver antenna units is greater than or substantially equal to a ½ wavelength of an operating frequency of the antenna module.

19. The surrounding detection radar of claim 16, wherein the second transmitter end comprises a second transmitter antenna array having a plurality of second transmitter antenna units connected in series, and the second receiver end comprises 2 second receiver antenna arrays having a plurality of second receiver antenna units connected in series.

20. The surrounding detection radar of claim 19, wherein a distance between the second receiver antenna arrays is greater than or substantially equal to a ½ wavelength of an operating frequency of the antenna module.
